(19) United States
(12) Patent Application Publication
(10) Pub. No.: US 2021/0103623 A1
(43) Pub. Date: Apr. 8, 2021

(54) MEDIA SOURCE MEASUREMENT FOR INCORPORATION INTO A CENSORED MEDIA CORPUS

(71) Applicant: GOOGLE LLC, Mountain View, CA (US)

(72) Inventor: Scott PETERSON, San Jose, CA (US)

(21) Appl. No.: 17/043,601

(22) PCT Filed: Jun. 29, 2018
(86) PCT No.: PCT/US18/40446

§ 371 Date: Sep. 29, 2020

(51) Int. Cl. G06F 16/954; G06F 16/9536; G06F 16/9538; G06N 5/02

(52) U.S. Cl. CPC G06F 16/954; G06N 5/022; G06F 16/9538; G06F 16/9536

(57) ABSTRACT

The disclosure provides technology for analyzing search events to measure and select media sources to use when incorporating content into a restricted media corpus. An example method includes determining a search characteristic of a plurality of search events of a first media corpus; identifying a set of search events of a second media corpus, wherein the set of search events corresponds to the search characteristic and comprises a search event that references a plurality of media sources; extracting a set of media sources associated with the second media corpus from the set of search events; selecting, by a processing device, a media source from the set of media sources based on a measurement of the media source, wherein the measurement is based on search events that reference the media source; and incorporating content into the first media corpus from the media source associated with the second media corpus.

### TECHNICAL FIELD

This disclosure relates to the field of content-sharing platforms and, in particular, to measuring media sources to enhance the identification of media items.

### BACKGROUND

Modern content sharing networks enable users to access and consume media content. The content sharing networks often include aspects that allow users to store and share media content with other users. The media content may include video content, audio content, other content, or a combination thereof. The content may include content from professional content creators, e.g., movies, television clips, and music, as well as content from amateur content creators, e.g., video blogging and short original videos. The media content is often shared with minimal restrictions to encourage the use and the dissemination of the content.

### SUMMARY

The following is a simplified summary of the disclosure in order to provide a basic understanding of some aspects of the disclosure. This summary is not an extensive overview of the disclosure. It is intended to neither identify key or critical elements of the disclosure nor delineate any scope of the particular embodiments of the disclosure or any scope of the claims. Its sole purpose is to present some concepts of the disclosure in a simplified form as a prelude to the more detailed description that is presented later.

In a first aspect of the present disclosure there is provided a method. The method comprises; determining a search characteristic of a plurality of search events of a first media corpus; identifying a set of search events of a second media corpus, wherein the set of search events corresponds to the search characteristic and comprises a search event that references a plurality of media sources; extracting a set of media sources associated with the second media corpus from the set of search events; selecting, by a processing device, a media source from the set of media sources based on a measurement of the media source, wherein the measurement is based on search events that reference the media source; and incorporating content into the first media corpus from the selected media source associated with the second media corpus.

The method may further comprise: analyzing a log comprising the plurality of search events of the first media corpus, wherein at least one of the plurality of search events comprises a search term and is linked to the search characteristic.

The search characteristic may comprise a knowledge graph identifier.

The first media corpus may comprise a collection of media items that comprise content characteristics for a class of individuals within a particular age range.

The media source may comprise a media channel and the content comprises video content.

Extracting the set of media sources may comprise identifying a set of media channels referenced by the set of search events of the second media corpus.

Selecting the media source from the set of media sources associated with the second media corpus may comprises: identifying search events in the set that reference the media source, wherein each of the identified search events comprises an order of media sources; determining a position of the media source within the order; and calculating the measurement of the media source based on the position of the media source and a quantity of search events in the set of search events that corresponds to the search characteristic; and selecting the media source having a largest predetermined measurement.

The predetermined measurement may be a largest measurement.

The method may further comprise calculating the measurement of the media source based on an average rank, r, of the media source in the set of search events and on a violation value, pv, of the media source in view of the following equation: Measurement=1/(r*(pv+1)).

Determining the search characteristic of the plurality of search events of the first media corpus may comprise: classifying search events of the first media corpus into multiple groups; selecting one or more groups of the multiple groups based on a predetermined threshold; identifying a plurality of search characteristics associated with the one or more groups of search events; and consolidating the plurality of search characteristics to a set of unique search characteristics; and selecting the search characteristic from the set of unique search characteristics based on a quantity of search events associated with the search characteristic.

In a second aspect of the present disclosure there is provided a system comprising: a memory; and a processing device communicably coupled to the memory, the processing device configured to carry out the method according to the first aspect.

In a third aspect of the present disclosure there is provided a non-transitory computer-readable storage medium comprising instructions to cause a processing device to carry out the method according to the first aspect.

### BRIEF DESCRIPTION OF THE DRAWINGS

The present disclosure is illustrated by way of example, and not by way of limitation, in the figures of the accompanying drawings.

FIG. 1 illustrates an example system architecture in accordance with an implementation of the disclosure.

FIG. 2 is a block diagram illustrating an example computing device with components and modules in accordance with an implementation of the disclosure.

FIG. 3 is a flow diagram illustrating an example of method in accordance with an implementation of the disclosure.

FIG. 4 is a block diagram illustrating another example of a computing device in accordance with an implementation of the disclosure.

These drawings may be better understood when observed in connection with the following detailed description.

### DETAILED DESCRIPTION

Modern content sharing platforms often organize content to better enable a user to find and consume content. The content may be organized in any manner and is often organized into multiple media sources. The media sources may function in a manner similar to media channels and may be based on content available from a common source or content having a common topic or theme. The content sharing platform may also organize the content based on particular classes of individuals (e.g., children). The content available to these classes of individuals may need to be carefully selected to ensure inappropriate content is not included. Identifying which content is and is not available for consumption may be referred to as content curation.

Content curation may involve selecting which pieces of content are appropriate for the particular class of individuals and may include manual or automatic content curation. Content curation is often challenging because media sources are incentivized to provide content that exploits selection techniques and circumvents any content restrictions. The content restrictions are often enforced by analyzing the content of digital media. In one example, the content sharing platform may create customized content classifiers (e.g., machine learning classifiers) that can identify and remove particular types of inappropriate content. Analyzing the content itself may be problematic because digital image processing techniques may be resource intensive and the customized content classifiers may take time to train.

Aspects and implementations of the present disclosure are directed to technology for incorporating or restricting content based on analysis of the source of the content as opposed to only an analysis of the content itself. In one example, the technology may involve analyzing search events that may correspond to search queries initiated by end users attempting to identify content for consumption. Some of the search events may correspond to a first media corpus and some of the search events may correspond to a second media corpus. The first media corpus may include a restricted set of content (e.g., censored media corpus) that is deemed appropriate for a particular class of individuals (e.g., children) and the second media corpus may include a larger and less restricted set of content (e.g., general media corpus). The technology may analyze the search events of the first media corpus to determine search characteristics (e.g., topics, themes) common to the search events of the first media corpus. This may indicate content that is interesting to a content consumer but missing from the first media corpus.

The technology may use the search characteristics to identify a set of search events of a second media corpus that correspond to the same or similar search characteristics. The set of search events of the second media corpus may include search events that reference a plurality of media sources related to the search characteristics (e.g., media channels that provide video content being searched for). The technology may analyze the search events of the second media corpus to extract a set of media sources and calculate a measurement for each of the media sources. The measurement may function as a reputation rating (e.g., trust score) of the media source and may be based on the number of search events that reference the media source as well as the rating and violations associated with the media source. The measurements may be used to select a media source of the second media corpus that can be used to incorporate content into the first media corpus. Selecting sources with favorable measurements (e.g., high trust score) may enhance the content incorporated into the first media corpus and minimize the risk that the content includes inappropriate content that would be unacceptable to consumers of the first media corpus (e.g., child viewers).

Systems and methods described herein include technology that enhances the technical field of content sharing platforms, by addressing technical problems associated with how to determine and restrict content from being shared in a content sharing platform. In particular, the technology disclosed improves content curation and restriction techniques by incorporating media source measurements so that the techniques can more accurately detect inappropriate content and be more resistant to classifier exploits. This may be accomplished by including an analysis of the media source in addition to or as an alternative to an analysis of the content alone. The accuracy may be further enhanced by analyzing search events that include historical user selections of search terms and particular search results.

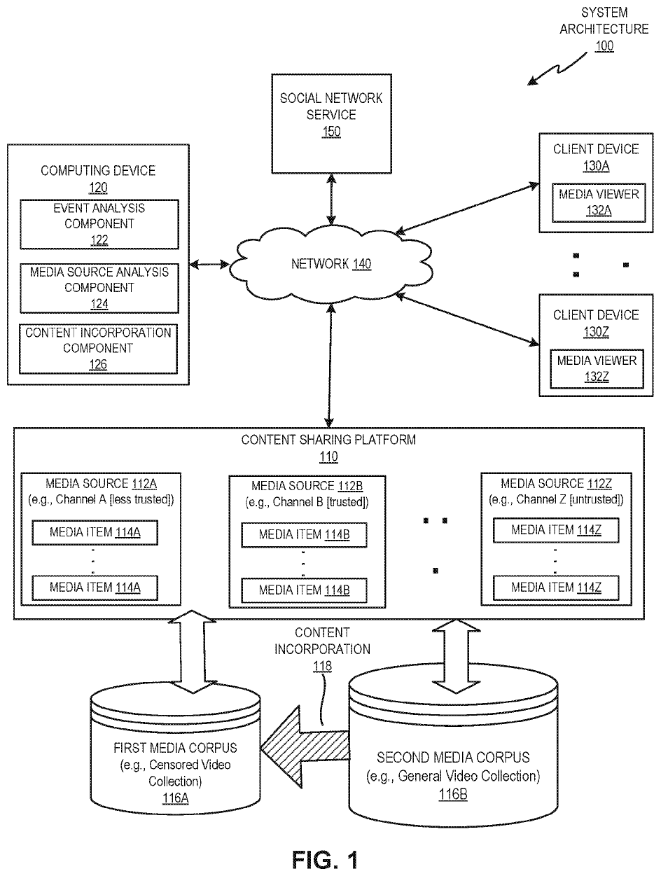

FIG. 1 illustrates an example system architecture 100 for measuring media sources and incorporating content into a restricted media corpus, in accordance with an implementation of the disclosure. The system architecture 100 may include a content sharing platform 110, a computing device 120, one or more client devices 120A-Z, and a network 140.

Content sharing platform 110 may be one or more computing devices (such as a rackmount servers, a server computer, a personal computer, a mainframe computer, a laptop computer, a tablet computer, a desktop computer, a routers, etc.), data stores (e.g., hard disks, memories, databases), networks, software components, and/or hardware components that may be used to provide a user with access to media items and/or provide the media items to the user. For example, the content sharing platform 110 may allow a user to consume, upload, search for, approve of (“like”), dislike, and/or otherwise comment on media items. Content sharing platform 110 may include one or more websites (e.g., a webpage) or one or more applications (e.g., mobile app) that provide users with access to media items 114A-Z.

Media items 114A-Z may include, but are not limited to, digital video, digital movies, digital photos, digital music, website content, social media updates, electronic books (e-books), electronic magazines, digital newspapers, digital audio books, electronic journals, web blogs, real simple syndication (RSS) feeds, electronic comic books, software applications, etc. In some implementations, a media item may be referred to as a content item and may be consumed via the Internet and/or via a mobile device application. For brevity and simplicity, an online video (also hereinafter referred to as a video) is used as an example of a media item throughout this document. As used herein, “media,” “media item,” “online media item,” “digital media,” “digital media item,” “content,” and “content item” can include an electronic file or record that can be executed or loaded using software, firnware, or hardware configured to present the digital media item to an entity. In one implementation, content sharing platform 110 may store media items 114A-Z using one or more data stores. The media items may be associated with a first media corpus, a second media corpus, or a combination thereof.

First media corpus 116A and second media corpus 116B may each be a collection of media items that are available on the content sharing platform 110. First media corpus 116A may be a restricted collection that includes content intended to be more appropriate for a particular class of individuals. The restricted collection may also be referred to as a censored collection, a protected collection, other collection, or a combination thereof. First media corpus 116A may have media items that include or exclude one or more content characteristics based on a particular class of individuals associated with the first media corpus 116A. The particular class of individuals may be associated with one or more human characteristic of the class and may be related to a maturity level (e.g., age group), mental capacity (e.g., 4^{th} grade comprehension level), disability (e.g., color blind, hearing impaired, visually impaired), other common feature, or a combination thereof. The content characteristics of the media items may relate to subject matter of the content and indicate the presence or absence of violence, profanity, nudity, substance abuse, other classification, or a combination thereof. The content characteristics may be related to one or more classifications or categories (e.g., general audience (G), Parental Guidance Suggested (PG), Parents Strongly Cautioned (PG-13), Restricted (R)). The content characteristics may also relate to the presence or absence of particular characters (e.g., main character), visual aspects (e.g., animated, non-animated), audio aspects (e.g., language locale, word complexity), other content characteristics, or a combination thereof.

Second media corpus 116B may be a general collection of media items that are associated with some or all of the content available on content sharing platform 110. Second media corpus 116B may be less restricted (e.g., less censored) than first media corpus 116A. The collections of media items that are associated with first media corpus 116A and second media corpus 116B may overlap or the collection of media items of first media corpus 116A may include media items that are exclusive to one or more collections and excluded from others. In one example, first media corpus 116A may be a restricted media corpus that is absent a portion of content available on second media corpus 116B. The restricted media corpus may include media items with content characteristics for one or more particular classes of individuals (e.g., children of a particular age range).

Media sources 112A-Z may function in a manner similar to media channels and may be based on content available from a common source or content having a common topic or theme. Media sources 112A-Z may provide media items to one or more users and may identify content available from a common source or data content having a common topic or theme. Media sources 112A-Z may provide media by adding media items to content sharing platform or by identifying existing media items that are already present on the content sharing platform. The media items may be added to content sharing platform 110 by an entity and may include user generated content (e.g., original content) created by the entity or may include existing content being added or reproduced to make it available on the content sharing platform 110. The media items may include digital content chosen by the entity, digital content made available by the entity, digital content uploaded by the entity, digital content chosen by a content provider, digital content chosen by a broadcaster, etc. For example, media source 112A can include one or more videos.

Each of the media sources 112A-Z may be associated with an entity (e.g., owner) that provides input for a respective media source. The input may initiate actions on behalf of the media source and may be attributed to the activity of the media source. The input may be user input provided by a human user or by a bot (e.g., software bot, web robot, internet bot). The activities of the media source may comply with or violate policies (e.g., guidelines, standards, rules, regulations, best practices) provided and enforced by content sharing platform 110. Activities of a media source that violate the policies may be represented by a violation value (pv) that is associated with the media source, entity, media item, or a combination thereof. The violation value may be a numeric or non-numeric value and include one or more integers, decimal value, percentages, letters, ratios, other value, or a combination thereof. In one example, the violation value may be a cumulative count of one or more violations (e.g., instances of inappropriate media item uploads) that have occurred during the existence of the media source or over a particular duration of time (e.g., day, week, year, decade, etc). The activity associated with a media source may include making digital content available, selecting existing digital content associated with another media source (e.g., liking, linking, tagging), the commenting on digital content, etc. The activities associated with the media source can be collected into an activity feed or profile associated with the media source. Users, other than the owner of the media source, can subscribe to one or more media sources to be presented with information from the activity feed of the media source. If a user subscribes to multiple media sources, the activity feed for each media source to which the user is subscribed can be combined into a syndicated activity feed. Information from the syndicated activity feed can be presented to the user.

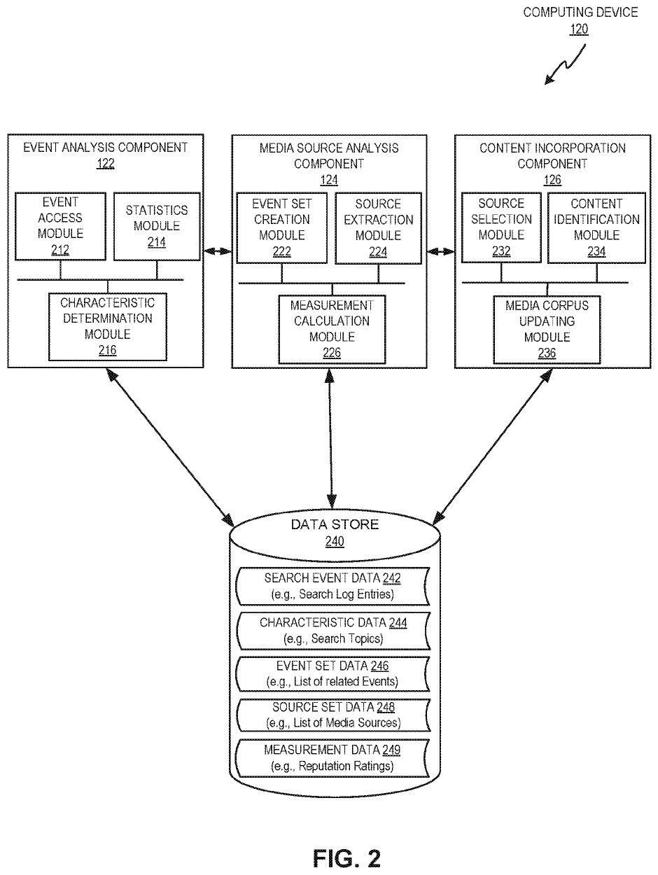

Computing device 120 may be one or more computing devices (e.g., a rackmount server, a server computer, etc.) that can analyze aspects of content sharing platform 110 to add or remove content from first media corpus 116A, second media corpus 116B, or a combination thereof. Computing device 120 may be integrated with content sharing platform 110 or may be separate from content sharing platform 110. In one example, computing device 120 may include an event analysis component 122, a media source analysis component 124, and a content incorporation component 126. Event analysis component 122 may enable computing device 120 to analyze search events of content sharing platform 110. The search events may correspond to search queries initiated by end users attempting to identify content for consumption. Some of the search events may correspond to first media corpus 116A and some of the search events may correspond to second media corpus 116B. The search events may provide data indicating the characteristics (e.g., topics) being searched within a respective media corpus. The search events may also provide data related media sources 112A-Z that provide content related to the characteristics being searched in the first media corpus 116A. Media source analysis component 124 may analyze and measure media sources extracted from the search events of the second media corpus 116B. Content incorporation component 126 may then select one of the media sources (e.g., media source with the largest measurement) and perform content incorporation 118 to update first media corpus 116A to include content from second media corpus 116B. Further description of the components 122, 124, and 126 and their functions are described in more detail below with respect to FIG. 2.

Client devices 130A-Z may each include computing devices such as personal computers (PCs), laptops, mobile phones, smart phones, tablet computers, netbook computers etc. In some implementations, client device 130A-Z may also be referred to as “user devices.” Each client device may include a media viewer 132A-Z, which may be an application that enables a user to view a media item, such as images, videos, web pages, documents, etc. In one example, the media viewer may be part of a standalone or dedicated application (e.g., mobile application). In another example, the media viewer 132A-Z may be incorporated into a generic web browser that can access, retrieve, present, and/or navigate content (e.g., web pages such as Hyper Text Markup Language (HTML) pages, digital media items, etc.) served by a web server. In either example, media viewers 132A-Z may enable client devices 120A-Z to present media items to a user (e.g., digital videos, digital images, electronic books, etc.). The media viewer may render, display, and/or present the content (e.g., a media item) to a user. Media viewers 132A-Z may be provided to client devices 130A-Z by computing device 120 and/or content sharing platform 110.

In general, functions described in one implementation as being performed by computing device 120, content sharing platform 110, or client devices 120A-Z may be performed by one or more of the other devices or platforms in other implementations. In addition, the functionality attributed to a particular component can be performed by different or multiple components operating together. The content sharing platform 110 may also be accessed as a service provided to other systems or devices through appropriate application programming interfaces, and thus is not limited to use in websites. Although implementations of the disclosure are discussed in terms of content sharing platforms, the implementations may also incorporate one or more features of a social network service 150 that provide connections between users.

In situations in which the systems discussed herein collect personal information about client devices or users, or may make use of personal information, the users may be provided with an opportunity to control whether the content sharing platform 110 can collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the content sharing platform 110.

Network 140 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

FIG. 2 depicts a block diagram illustrating an exemplary computing device 120 that includes technology for analyzing search events to identify and select a media source for incorporating content into a first media corpus (e.g., censored collection), in accordance with one or more aspects of the present disclosure. Computing device 120 may include an event analysis component 122, a media source analysis component 124, and a content incorporation component 126. More or less components or modules may be included without loss of generality. For example, two or more of the components may be combined into a single component, or features of a component may be divided into two or more components. In one implementation, one or more of the components may reside on different computing devices (e.g., a server device and a client device).

Event analysis component 122 may enable computing device 120 to analyze search event data 242 derived from search events of content sharing platform 110. In one example, event analysis component 122 may include an event access module 212, a statistics module 214, and a characteristic determination module 216.

Event access module 212 may enable computing device 120 to access search events of the content sharing platform. The search events may correspond to search requests or search queries initiated by client devices attempting to identify content for consumption. A search event may include or indicate one or more search terms, search results, user selections, other data, or a combination thereof. The search terms may include textual data (e.g., keywords), image data (e.g., picture), audio data (e.g., sound track), other data, or a combination thereof. The search results may include one or more media items, media sources, other data, or a combination thereof. The search events may be accessed from one or more communication channels (e.g., search API, log API, enterprise bus) or from one or more data structures. In one example, the search events may be accessed from a log data structure.

The log data structure may include one or more entries representing respective search events. The log data structure may include a log file, a log database, other log data structure, or a combination thereof. The log data structure may be referred to as an event log, web log, data log, message log, transaction log, journal, other event tracking construct, or a combination thereof. In one example, the first media corpus and the second media corpus may have separate log data structures. In another example, the first media corpus and the second media corpus may share one or more log data structures and the log data structures or events may indicate whether they correspond to the first media corpus, the second media corpus, or a combination thereof. In either example, event access module 212 may access the log data structure and retrieve search event data corresponding to portions of one or more search events.

Statistics module 214 may analyze the search events and determine statistical data based on the search events. The statistical data may represent one or more search events or one or more groups of search events and may indicate the quantity of occurrences of a search event or number of search events within a group. Statistics module 214 may perform operations that include clustering, classifying, arranging, other operation, or a combination thereof that organize the search events of a media corpus into one or more groups. The search events within a group may correspond to a particular time duration, language locale, geographic region, media corpus, search characteristic, other aspect, or a combination thereof. In one example, statistics module 214 may indicate the most popular search events (e.g., search queries) with a response (e.g., click) in each language locale (e.g., English locale, Spanish locale, Russian locale, Japanese locale, etc.). In another example, statistics module 214 may indicate the most popular media sources within a group of search events related to a particular search characteristic. In either example, the group may include search events specific to the first media corpus, the second media corpus, or a combination thereof.

Characteristic determination module 216 may determine one or more search characteristics associated with a group of search events. A search characteristic may be stored as characteristic data 244 and may be any characteristic related to a search event or group of search events. As discussed above, a search event may be a search request or search query and may be associated with one or more search terms and search results. The search terms may be associated with a literal meaning, a semantic meaning, or a combination thereof. A search characteristic may represent the meaning associated with the search event and may be the same or similar to a topic, theme, subject, classification, category, other concept, or a combination thereof. The search characteristics may be associated with one or more of the search events or portions of the search events. For example, the search characteristics may be associated with a search event as a whole or may be associated with a portion of a search event, such as one or more of the search terms, search results, or user selection data, other portion, or a combination thereof.

Characteristic determination module 216 may access data of event access module 212 and statistics module 214 to determine search characteristics associated with popular search events (e.g., the most popular search queries). As discussed above, statistics module 214 may identify the most popular groups of search events within the first media corpus. The most popular groups of search events may represent content users are requesting to access from the first media corpus, which may be a censored collection of media items. The content may or may not be available within the first media corpus but the existence of the search events may indicate a desire for the content to be included. Characteristic determination module 216 may analyze each of the groups to identify search characteristics associated with the group.

In one example, characteristic determination module 216 may determine the search characteristic of a plurality of search events of a first media corpus by classifying or clustering search events of the first media corpus into multiple groups based on one or more search terms or search characteristics. Characteristic determination module 216 may then select one or more groups of the multiple groups based on a predetermined threshold. The threshold may be based on a number of search events, a number of search events in a group, a number of groups, other number, or a combination thereof. Characteristic determination module 216 may then identify a plurality of search characteristics associated with the one or more groups of search events that satisfy (e.g., above or below) the predetermined threshold. The search characteristics may be consolidated down to a set of unique search characteristics that removes or merges search characteristics that are the same or similar. In one example, characteristic determination module 216 may analyze the groups of search events from the first media corpus that make up the top X % e.g., 20%) of the search events during a particular duration (e.g., past day, week, month, etc) and/or with a user selection in each of one or more language locales.

The search characteristics may be represented by one or more identifiers of a knowledge graph. The knowledge graph may be a data structure that stores ontological data and knowledge graph identifiers. The ontological data may include formal or informal names and definition of factual items, types, properties, and interrelationships of the factual items. The knowledge graph identifiers (KG ID) may include identification data (e.g., numeric or non-numeric data) that corresponds to a particular concept (e.g., factual item, topic, theme). The knowledge graph identifier may by assigned, linked, or associated with a media item (e.g., video), media source (e.g., video channel), search event (e.g. search term or result), other object, or a combination thereof and may indicate whether the object relates to the concept corresponding to the knowledge graph identifier. The knowledge graph may be the same or similar to a knowledge base, a knowledge engine, knowledge organization, other factual store, or a combination thereof. In one example, there may be a single knowledge graph that covers the characteristics of all the media items. In another example, there may be multiple knowledge graphs and each may cover a particular field or area.

Characteristic determination module 216 may also associate search events or groups of search events with search characteristics. In one example, characteristic determination module 216 may associate (e.g., assign, label) search events with corresponding search characteristics. In another example, characteristic determination module 216 may access and analyze search events that have already been assigned search characteristics. The search characteristics may have been assigned by computing device 120, by content sharing platform, other computing device, or a combination thereof.

Media source analysis component 124 may discover media sources by analyzing search events of the second media corpus based on the search characteristics of the first media corpus. Media source analysis component 124 may then analyze the media sources and calculate measurements that represent the reputation (e.g., trustworthiness) of the media sources. In one example, media source analysis component 124 may include an event set creation module 222, a source extraction module 224, and a measurement calculation module 226.

Event set creation module 222 may identify a set of search events of a second media corpus that correspond to the one or more search characteristic derived from the first media corpus. Event set creation module 222 may scan a log data structure associated with the second media corpus and return the search events that are related to the one or more search characteristics. Event set creation module 222 may store these search events as event set data 246. Each of the search events may include search results that reference one or more media sources. The references may be the same or similar to search results returned from a search engine and may include links to a media item available from a media source.

Source extraction module 224 may analyze the set of search events and extract the media sources. There may be many search events in the set and one or more of the search events may reference the same media sources. Source extraction module 224 may combine (e.g., filter, merge, deduplicate) the sources of the search events and produce a set of unique media sources. Each of the media sources in the set may be associated with the second media corpus and data identifying the media source may be stored within source set data 248. In one example, the media sources may be media channels that provide video content.

Measurement calculation module 226 may analyze the set of media sources and generate measurements for the media sources. The measurements may be stored as measurement data 249 in data store 240. The measurements may be the same or similar to ratings, scores, points, weights, grades, ranks, other assessment value, or a combination thereof. The measurements may include numeric or non-numeric data and may indicate a reputation of the media source for providing media items that violate or do not violate policies. The measurement for a media source may be based on a quantity of search events that reference the media source and/or the ranking of the media source within the search results of the search events. In one example, a measurement of a media source may be calculated based on an average rank (r) of the media source in the set of search events and on a violation value (pv) of the media source in view of the following equation: Measurement=1/(r*(pv+1)). In other examples, the measurement of a media source may also or alternatively be based on historical user feedback (e.g., click count) regarding the media source referend by the search results of the search events.

In one example, measurement calculation module 226 may analyze search events that include an order of the search results. Measurement calculation module 226 may determine a position within the order (e.g., rank) of the media source and use it as part of the measurement calculation. Module 226 may also take into account a quantity of search events in the set of search events that corresponds to the search characteristic (e.g., to make it a cumulative rank or average rank). Other data may be used to calculate the measurement and may include one or more of a violation value, an engagement value (e.g., likes, shares, favorites), a consumption value (e.g., quantity and/or duration of consumption), a viewership value (e.g., number of unique or non-unique viewers), other value, or a combination thereof.

Content incorporation component 126 may select a media source and update the first media corpus 116A to include content available from the second media corpus 116B. In one example, content incorporation component 126 may include a source selection module 232, a content identification module 234, and a media corpus updating module 236.

Source selection module 232 may select a media source from the set of media sources identified by source extraction module 224. The selection may be based on one or more measurements of measurement calculation module 226. In one example, source selection module 232 may sort the set of media sources based on measurements and select the media source with the highest or lowest value.

Content identification module 234 may identify the content based on the selected media source. In one example, the media source may identify a particular media item. In another example, the media source may identify a media channel that provides multiple different media items and content identification module 234 may search the media channel to identify the media item corresponding to the search characteristics. In either example, the computing device may access the media item or media item identification data (e.g., link) and provide the information to media corpus updating module 236.

Media corpus updating module 236 may update the first media corpus to include a media item of the second media corpus. The second media corpus may include media items that are the same or similar and may choose the media item from the selected media source in view of the data provided by content identification module 234. Incorporating content into the first media corpus may involve updating media identification data of a collection of media items associated with the first media corpus. In one example, the content of the media item may not be modified or copied during the update and only the identification information of the media item may be involved in the update. In another example, the content of the media item may be copied (e.g., duplicated, replicated) to a new storage location accessible by the first media corpus.

Data store 240 may be a memory (e.g., random access memory), a cache, a drive (e.g., a hard drive), a flash drive, a database system, or another type of component or device capable of storing data. Data store 240 may also include multiple storage components (e.g., multiple drives or multiple databases) that may also span multiple computing devices (e.g., multiple server computers).

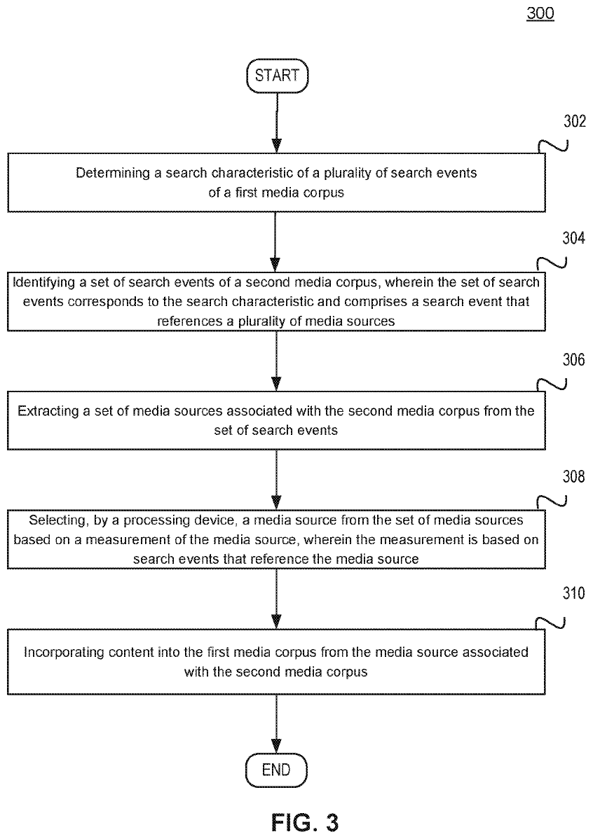

FIG. 3 depicts a flow diagram of one illustrative example of a method 300 for analyzing search events to identify media sources to use when incorporating content into a restricted media corpus, in accordance with one or more aspects of the present disclosure. Method 300 and each of its individual functions, routines, subroutines, or operations may be performed by one or more processors of the computer device executing the method. In certain implementations, method 300 may be performed by a single computing device. Alternatively, methods 300 may be performed by two or more computing devices, each computing device executing one or more individual functions, routines, subroutines, or operations of the method.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 300 may be performed by components 122, 124, and 126 of FIGS. 1 and 2.

Method 300 may be performed by processing devices of a server device or a client device and may begin at block 302. At block 302, a processing device may determine a search characteristic of a plurality of search events of a first media corpus. Determining the search characteristic may involve classifying search events of the first media corpus into multiple groups based on one or more search characteristics. One or more of the multiple groups may be selected based on a predetermined threshold (e.g., most popular group). The processing device may identify a plurality of search characteristics associated with the one or more groups of search events and consolidate the plurality of search characteristics to a set of unique search characteristics. The processing device may then select the search characteristic from the set of unique search characteristics based on a quantity of search events associated with the search characteristic. In one example, determining the search characteristics may involve analyzing a log (e.g., log data structure) that includes the search events of the first media corpus. Each of the search events of the first media corpus may include a search term and may be linked to (e.g., labeled with) the search characteristic.

At block 304, the processing device may identify a set of search events of a second media corpus. The set of search events may correspond to the search characteristic and may include a search event that references a plurality of media sources. The search characteristic may be a knowledge graph identifier and the processing device may search through the search events of the second media corpus to identify a set of search events that are related to the knowledge graph identifier discovered from the first media corpus. In one example, the processing device may identify the set by analyzing a log comprising the search events of the second media corpus. Each of the search events of the second media corpus may include a search term and search results referencing the plurality of media sources.

At block 306, the processing device may extract a set of media sources associated with the second media corpus from the set of search events. Each media source may be a media channel that provides video content and extracting the set of media sources may involve identifying a set of media channels referenced by the set of search events of the second media corpus. In one example, the first media corpus may comprise a restricted video corpus (e.g., censored corpus) and be absent a portion of content available in the second media corpus. The restricted video corpus may be a collection of media items that have content characteristics that accommodate a particular class of individuals. The class of individuals may be based on a particular age range of children viewers.

At block 308, the processing device may select a media source from the set of media sources based on a measurement of the media source. The measurement may be based on search events that reference the media source. Selecting the media source from the set may involve identifying search events that reference the media source. In one example, each of the identified search events may include an order for the referenced media sources and the processing device may determine a position of a particular media source within the order. The processing device may calculate a measurement for the particular media source based on the position and a quantity of search events of the set that correspond to the search characteristic. The processing device may then select the media source having a largest measurement. In one example, the processing device may calculate the measurement of the media source based on an average rank (r) of the media source in the set of search events and on a violation value (pv) of the media source in view of the following equation: Measurement=1/(r*(pv+1))

At block 310, the processing device may incorporate content into the first media corpus from the media source associated with the second media corpus. Incorporating content into the first media corpus may involve updating media identification data of a collection of media items associated with the first media corpus. In one example, the content of the media item may not be moved or copied during the update and only the identification information of the media item may be involved in the update. In another example, the content of the media item may be copied (e.g., duplicated, replicated) to a new storage location accessible by the first media corpus. Responsive to completing the operations described herein above with references to block 310, the method may terminate.

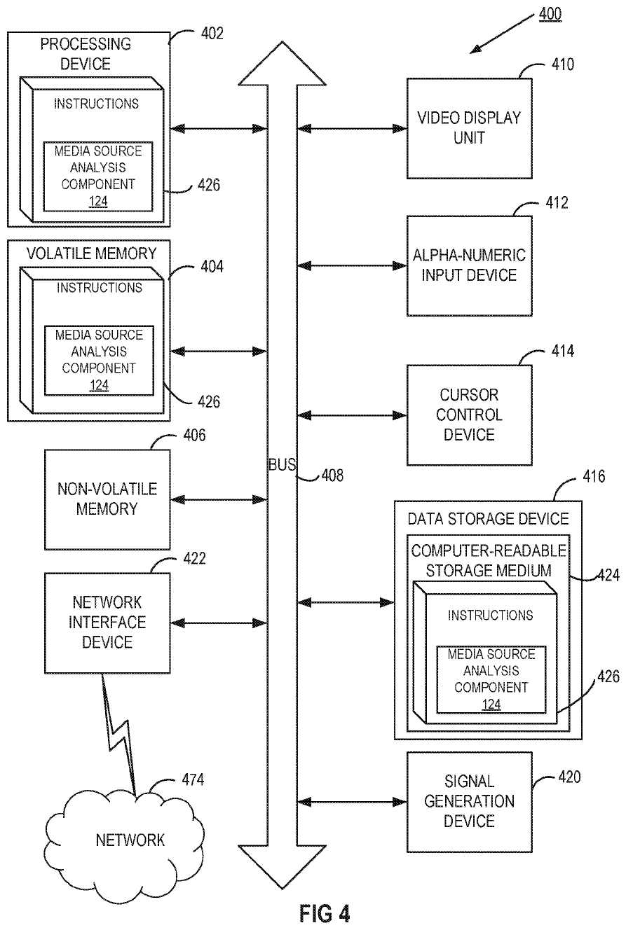

FIG. 4 depicts a block diagram of a computer system operating in accordance with one or more aspects of the present disclosure. In various illustrative examples, computer system 400 may correspond to computing device 120 of FIGS. 1 and 2. The computer system may be included within a data center that supports virtualization. In certain implementations, computer system 400 may be connected (e.g., via a network, such as a Local Area Network (LAN), an intranet, an extranet, or the Internet) to other computer systems. Computer system 400 may operate in the capacity of a server or a client computer in a client-server environment, or as a peer computer in a peer-to-peer or distributed network environment. Computer system 400 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 400 may include a processing device 402, a volatile memory 404 (e.g., random access memory (RAM)), a non-volatile memory 406 (e.g., read-only memory (ROM) or electrically-erasable programmable ROM (EEPROM)), and a data storage device 416, which may communicate with each other via a bus 408.

Processing device 402 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 400 may further include a network interface device 422. Computer system 400 also may include a video display unit 410 (e.g., an LCD), an alphanumeric input device 412 (e.g., a keyboard), a cursor control device 414 (e.g., a mouse), and a signal generation device 420.

Data storage device 416 may include a non-transitory computer-readable storage medium 424 on which may store instructions 426 encoding any one or more of the methods or functions described herein, including instructions for implementing method 300 and for media source analysis component 124 of FIGS. 1 and 2.

Instructions 426 may also reside, completely or partially, within volatile memory 404 and/or within processing device 402 during execution thereof by computer system 400, hence, volatile memory 404, and processing device 402 may also constitute machine-readable storage media.

While computer-readable storage medium 424 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer and cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware resources. Further, the methods, components, and features may be implemented in any combination of hardware resources and computer program components, or in computer programs.

Unless specifically stated otherwise, terms such as “initiating,” “transmitting,” “receiving,” “analyzing,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods 300 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
determining a search characteristic of a plurality of search events of a first media corpus;
identifying a set of search events of a second media corpus, wherein the set of search events corresponds to the search characteristic and comprises a search event that references a plurality of media sources;
extracting a set of media sources associated with the second media corpus from the set of search events;
selecting, by a processing device, a media source from the set of media sources based on a measurement of the media source, wherein the measurement is based on search events that reference the media source; and
incorporating content into the first media corpus from the selected media source associated with the second media corpus.

2. The method of claim 1, further comprising: analyzing a log comprising the plurality of search events of the first media corpus, wherein at least one of the plurality of search events comprises a search term and is linked to the search characteristic.

3. The method of claim 1, wherein the search characteristic comprises a knowledge graph identifier.

4. The method of claim 1, wherein the first media corpus comprises a collection of media items that comprise content characteristics for a class of individuals within a particular age range.

5. The method of claim 1, wherein the media source comprises a media channel and the content comprises video content.

6. The method of claim 1, wherein extracting the set of media sources comprises identifying a set of media channels referenced by the set of search events of the second media corpus.

7. The method of claim 1, wherein selecting the media source from the set of media sources associated with the second media corpus comprises:
identifying search events in the set that reference the media source, wherein each of the identified search events comprises an order of media sources;
determining a position of the media source within the order; and
calculating the measurement of the media source based on the position of the media source and a quantity of search events in the set of search events that corresponds to the search characteristic; and
selecting the media source having a predetermined measurement.

8. The method of claim 7, wherein the predetermined measurement is a largest measurement.

9. The method of claim 1, further comprising calculating the measurement of the media source based on an average rank, r, of the media source in the set of search events and on a violation value, pv, of the media source in view of the following equation:
Measurement=1/(r*(pv+1)).

10. The method of claim 1, wherein determining the search characteristic of the plurality of search events of the first media corpus comprises:
classifying search events of the first media corpus into multiple groups;
selecting one or more groups of the multiple groups based on a predetermined threshold;
identifying a plurality of search characteristics associated with the one or more groups of search events; and
consolidating the plurality of search characteristics to a set of unique search characteristics; and
selecting the search characteristic from the set of unique search characteristics based on a quantity of search events associated with the search characteristic.

11. A system comprising:
a memory; and
a processing device communicably coupled to the memory, the processing device configured to:
determine a search characteristic of a plurality of search events of a first media corpus;
identify a set of search events of a second media corpus, wherein the set of search events corresponds to the search characteristic and comprises a search event that references a plurality of media sources;
extract a set of media sources associated with the second media corpus from the set of search events;
select a media source from the set of media sources based on a measurement of the media source, wherein the measurement is based on search events that reference the media source; and
incorporate content into the first media corpus from the selected media source associated with the second media corpus.

12. A non-transitory computer-readable storage medium comprising instructions to cause a processing device to perform operations comprising:
determining a search characteristic of a plurality of search events of a first media corpus;
identifying a set of search events of a second media corpus, wherein the set of search events corresponds to the search characteristic and comprises a search event that references a plurality of media sources;
extracting a set of media sources associated with the second media corpus from the set of search events;
selecting a media source from the set of media sources based on a measurement of the media source, wherein the measurement is based on search events that reference the media source; and
incorporating content into the first media corpus from the selected media source associated with the second media corpus.

13. The system of claim 11, wherein the processing device is further configured to analyze a log comprising the plurality of search events of the first media corpus, wherein at least one of the plurality of search events comprises a search term and is linked to the search characteristic.

14. The system of claim 11, wherein the search characteristic comprises a knowledge graph identifier.

15. The system of claim 11, wherein the first media corpus comprises a collection of media items that comprise content characteristics for a class of individuals within a particular age range.

16. The system of claim 11, wherein the media source comprises a media channel and the content comprises video content.

17. The non-transitory computer-readable storage medium of claim 12, wherein the operations further comprise:
determining a search characteristic of a plurality of search events of a first media corpus;
identifying a set of search events of a second media corpus, wherein the set of search events corresponds to the search characteristic and comprises a search event that references a plurality of media sources;
extracting a set of media sources associated with the second media corpus from the set of search events;
selecting a media source from the set of media sources based on a measurement of the media source, wherein the measurement is based on search events that reference the media source; and
incorporating content into the first media corpus from the selected media source associated with the second media corpus.

18. The non-transitory computer-readable storage medium of claim 12, wherein the operations further comprise:
analyzing a log comprising the plurality of search events of the first media corpus, wherein at least one of the plurality of search events comprises a search term and is linked to the search characteristic.

19. The non-transitory computer-readable storage medium of claim 12, wherein the search characteristic comprises a knowledge graph identifier.

20. The non-transitory computer-readable storage medium of claim 12, wherein the first media corpus comprises a collection of media items that comprise content characteristics for a class of individuals within a particular age range.
